(19) United States
(12) Patent Application Publication
(10) Pub. No.: US 2024/0037252 A1
(43) Pub. Date: Feb. 1, 2024

(54) METHODS AND APPARATUSES FOR JOINTLY UPDATING SERVICE MODEL

(71) Applicant: Alipay (Hangzhou) Information Technology Co., Ltd., Hangzhou (CN)

(72) Inventors: Longfei Zheng, Hangzhou (CN); Chaochao Chen, Hangzhou (CN); Li Wang, Hangzhou (CN); Benyu Zhang, Hangzhou (CN)

(73) Assignee: Alipay (Hangzhou) Information Technology Co., Ltd., Hangzhou (CN)

(21) Appl. No.: 18/485,765

(22) Filed: Oct. 12, 2023

Related U.S. Application Data
(63) Continuation of application No. PCT/CN2022/085876, filed on Apr. 8, 2022.

(30) Foreign Application Priority Data
Apr. 12, 2021 (CN) 202110390904.X

(51) Int. Cl. G06F 21/60

(52) U.S. Cl. CPC G06F 21/604

(57) ABSTRACT

This specification provides example computer-implemented methods and apparatuses for jointly updating a service model based on privacy protection. In an example iteration process, a serving party provides, to each data party, global model parameters and a mapping relationship between the data party and N parameter groups obtained by dividing the global model parameters. Each data party updates a local service model by using the global model parameters, and further updates an updated local service model based on local service data, to upload model parameters in a new service model in a parameter group corresponding to the data party to the serving party. Then, the serving party successively fuses received parameter groups to update the global model parameters.

### CROSS-REFERENCE TO RELATED APPLICATIONS

This application is a continuation of PCT Application No. PCT/CN2022/085876, filed on Apr. 8, 2022, which claims priority to Chinese Patent Application No. 202110390904.X, filed on Apr. 12, 2021, and each application is hereby incorporated by reference in its entirety.

### TECHNICAL FIELD

One or more embodiments of this specification relate to the field of computer technologies, and in particular, to methods and apparatuses for jointly updating a service model based on privacy protection.

### BACKGROUND

With the development of computer technologies, machine learning is increasingly widely used in various service scenarios. Federated learning is a method for joint modeling based on private data protection. For example, enterprises need to cooperate with each other for secure modeling, and federated learning can be performed, so that a data processing model is trained through cooperation by using data of the parties while enterprise data privacy is fully protected, so as to more accurately and effectively process service data. In a federated learning scenario, for example, after the parties agree on a model structure (or an agreed model), the parties respectively perform training locally by using private data, and aggregate model parameters by using a secure and trusted method. Finally, the parties improve local models based on the aggregated model parameters. Federated learning is implemented based on privacy protection, which effectively breaks data islands and implements multi-party joint modeling.

However, as task complexity and performance requirements are gradually increased, a quantity of network layers of a service model in federated learning is gradually increased, and correspondingly, there are increasingly more model parameters. A facial recognition ResNET-50 is used as an example. An original model has more than 20 million parameters, and a size of the model exceeds 100 MB. In particular, in a scenario in which a large quantity of training members participate in federated learning, a quantity of data received by a server increases by a geometric multiple, which possibly cause communication blocking and severely affect overall training efficiency.

### SUMMARY

One or more embodiments of this specification describe methods and apparatuses for jointly updating a service model, to resolve one or more problems mentioned in the background.

According to a first aspect, a method for jointly updating a service model is provided. The method is used by a plurality of data parties to jointly train a service model based on privacy protection with the assistance of a serving party, the service model is used to process service data to obtain a corresponding service processing result, and the method includes: The serving party provides, to each data party, global model parameters and a mapping relationship between the data party and N parameter groups obtained by dividing the global model parameters; each data party updates a local service model by using the global model parameters; each data party further updates an updated local service model based on local service data to obtain a new local service model, and uploads model parameters in a parameter group corresponding to the data party to the serving party; and the serving party fuses, for each parameter group, the received model parameters to update the global model parameters.

According to one or more embodiments, that each data party further updates an updated local service model based on local service data to obtain a new local service model includes: Each data party detects a current phase transition indicator by using the local service data after updating the local service model by using the global model parameters; a data party whose phase transition indicator satisfies a full update stop condition enters a local update phase; and the data party entering the local update phase updates model parameters in a parameter group corresponding to the data party.

According to one or more embodiments, the phase transition indicator is model performance of the updated local service model, and the stop condition is that the model performance satisfies a predetermined value.

According to a second aspect, a method for jointly updating a service model is provided. The method is used in a serving party that assists a plurality of data parties in jointly training a service model based on privacy protection, the service model is used to process service data to obtain a corresponding service processing result, the plurality of data parties include a first party, and the method includes: Current global model parameters and a mapping relationship between the first party and a first parameter group in N parameter groups obtained by dividing the global model parameters are provided to the first party, so that the first party updates a local service model by using the current global model parameters, and feeds back a first parameter set for the first parameter group after further updating an updated local service model based on local service data to obtain a new local service model; the first parameter set fed back by the first party is received; and the first parameter group in the global model parameters is updated based on the first parameter set and another parameter set related to the first parameter group that is received from another data party, and then the current global model parameters are updated based on updating of the first parameter group.

According to one or more embodiments, the mapping relationship between the first party and the first parameter group is determined in the following method: The plurality of data parties are divided into M groups, where a single group of data parties corresponds to at least one data party, and the first party belongs to a first group in the M groups of data parties; and mapping relationships between the M groups of data parties and the N parameter groups are determined, where a single group of data parties corresponds to at least one parameter group, a single parameter group corresponds to at least one group of data parties, and a parameter group corresponding to the first group is the first parameter group.

According to one or more embodiments, that the plurality of data parties are divided into M groups includes one of the following: The plurality of data parties are divided into M groups with a target that quantities of service data held by the groups of data parties are consistent; or the plurality of data parties are divided into M groups with a target that a quantity of service data held by a single data party is positively correlated with a quantity of model parameters included in a corresponding parameter group.

In one or more embodiments, that the first parameter group in the global model parameters is updated based on the first parameter set and another parameter set related to the first parameter group that is received from another data party includes: The first parameter set and the another parameter set related to the first parameter group are fused in at least one of the following methods: performing weighted averaging, taking a minimum value, and taking a median; and the first parameter group in the global model parameters is updated based on a fusion result.

In one or more embodiments, that the current global model parameters are updated based on updating of the first parameter group includes: Other parameter groups are separately updated based on corresponding parameter sets fed back by several data parties respectively corresponding to the parameter groups, to update the current global model parameters.

According to a third aspect, a method for jointly updating a service model is provided. The method is used in a first party in a plurality of data parties that jointly train a service model based on privacy protection with the assistance of a serving party, the service model is used to process service data to obtain a corresponding service processing result, and the method includes: Current global model parameters and a mapping relationship between the first party and a first parameter group in N parameter groups obtained by dividing the global model parameters are received from the serving party; a local service model is updated by using the current global model parameters; local model parameters are updated in several rounds based on processing performed by an updated local service model on local service data; and a first parameter set obtained by updating the first parameter group is fed back to the serving party, so that the serving party updates the first parameter group in the global model parameters based on the first parameter set and another parameter set related to the first parameter group that is received from another data party, to update the current global model parameters.

In one or more embodiments, that an updated local service model is further updated based on local service data to obtain a new local service model includes: A current phase transition indicator of the updated local service model is detected by using the local service data; and a local update phase of updating the first parameter group is entered when the phase transition indicator satisfies a full update stop condition.

In one or more embodiments, a full update phase of updating all model parameters in the local service model continues when the phase transition indicator does not satisfy the stop condition.

In one or more embodiments, the phase transition indicator is model performance of the updated local service model, and the stop condition is that the model performance satisfies a predetermined value.

In one or more embodiments, in the local update phase, that an updated local service model is further updated based on local service data to obtain a new local service model includes: Whether the phase transition indicator satisfies a full update activation condition is detected; and a full update phase of updating all model parameters in the local service model is re-entered when the phase transition indicator satisfies the activation condition.

According to a fourth aspect, a system for jointly updating a service model is provided, including a serving party and a plurality of data parties, where the plurality of data parties jointly train a service model based on privacy protection with the assistance of the serving party, and the service model is used to process service data to obtain a corresponding service processing result. The serving party is configured to provide, to each data party, global model parameters and a mapping relationship between the data party and N parameter groups obtained by dividing the global model parameters; each data party is configured to update a local service model by using the global model parameters, and further update an updated local service model based on local service data to obtain a new local service model, to upload model parameters in a parameter group corresponding to the data party to the serving party; and the serving party is further configured to fuse, for each parameter group, the received model parameters to update the global model parameters.

According to a fifth aspect, an apparatus for jointly updating a service model is provided, and is disposed in a serving party that assists a plurality of data parties in jointly training a service model based on privacy protection, where the service model is used to process service data to obtain a corresponding service processing result, and the plurality of data parties include a first party. The apparatus includes: a providing unit, configured to provide, to the first party, current global model parameters and a mapping relationship between the first party and a first parameter group in N parameter groups obtained by dividing the global model parameters, so that the first party updates a local service model by using the current global model parameters, and feeds back a first parameter set for the first parameter group after further updating an updated local service model based on local service data to obtain a new local service model; a receiving unit, configured to receive the first parameter set fed back by the first party; and an updating unit, configured to update the first parameter group in the global model parameters based on the first parameter set and another parameter set related to the first parameter group that is received from another data party, and further update the current global model parameters based on updating of the first parameter group.

According to a sixth aspect, an apparatus for jointly updating a service model is provided, and is disposed in a first party in a plurality of data parties that jointly train a service model based on privacy protection with the assistance of a serving party, where the service model is used to process service data to obtain a corresponding service processing result. The apparatus includes: a receiving unit, configured to receive, from the serving party, current global model parameters and a mapping relationship between the first party and a first parameter group in N parameter groups obtained by dividing the global model parameters; a replacement unit, configured to update a local service model by using the current global model parameters; a training unit, configured to further update an updated local service model based on local service data to obtain a new local service model; and a feedback unit, configured to feed back, to the serving party, a first parameter set obtained by updating the first parameter group, so that the serving party updates the first parameter group in the global model parameters based on the first parameter set and another parameter set related to the first parameter group that is received from another data party, to update the current global model parameters.

According to a seventh aspect, a computer-readable storage medium is provided. The computer-readable storage medium stores a computer program, and when the computer program is executed in a computer, the computer is enabled to perform the method according to the second aspect or the third aspect.

According to an eighth aspect, a computing device is provided, including a memory and a processor. The memory stores executable code, and when executing the executable code, the processor implements the method according to the second aspect or the third aspect.

According to the methods and the apparatuses provided in the embodiments of this specification, in a process in which a plurality of parties cooperate with each other to jointly update a service model based on privacy protection, a plurality of data parties serving as training members are grouped, and each data party uploads only a part of model parameters, so that an amount of communication between each data party and a serving party and a quantity of data processed by the serving party can be effectively reduced, thereby avoiding communication blocking and helping improve overall training efficiency. The methods and the apparatuses are applicable to any federated learning process, and especially, when there are a large quantity of data parties or a large quantity of training samples, the above effects are more significant.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following description show merely some embodiments of this specification, and a person of ordinary skill in the art can derive other drawings from these accompanying drawings without creative efforts.

FIG. 1 is a schematic diagram illustrating an implementation architecture for jointly updating a service model based on privacy protection, according to a technical concept of this specification;

FIG. 2 is a flowchart illustrating a method for jointly updating a service model, according to one or more embodiments;

FIG. 3 is a schematic block diagram illustrating an apparatus for jointly updating a service model disposed in a serving party, according to one or more embodiments; and

FIG. 4 is a schematic block diagram illustrating an apparatus for jointly updating a service model disposed in a data party, according to one or more embodiments.

### DESCRIPTION OF EMBODIMENTS

The following describes the solutions provided in this specification with reference to the accompanying drawings.

Federated learning can also be referred to as federated machine learning, federated learning, federated learning, etc. Federated machine learning is a machine learning framework that can effectively help a plurality of institutions to use data and perform machine learning modeling while satisfying requirements of user privacy protection, data security, and government regulations.

Specifically, assume that enterprise A and enterprise B each establish a task model, a single task can be a classified task or predicted task, and these tasks have been approved by respective users when data are obtained. However, the data are incomplete, for example, enterprise A lacks label data, enterprise B lacks user feature data, or data are insufficient, and a sample amount is not large enough to establish a good model. As a result, a model at each end is possibly unable to be established or effects are not ideal. A problem to be resolved by federated learning is how to establish a high-quality model at each of end A and end B, and prevent self-owned data of each enterprise from being known to other parties, that is, to establish a common model without violating data privacy regulations. The common model is like an optimal model established by the parties by aggregating data together. As such, in an area of each party, the established model serves a target of only the party.

Each institution in federated learning can also be referred to as a service party, and each service party can correspond to different service data. For example, the service data here can be various types of data such as characters, pictures, audio, animations, and videos. Generally, service data of each service party are correlated. For example, among a plurality of service parties related to a financial service, service party 1 is a bank, which provides a user with services such as savings and loans, and can hold data such as the user's age, gender, income and expenditure, loan amount, and deposit amount; service party 2 is a P2P platform, which can hold data such as the user's borrowing and credit records, investment records, and repayment time limits; and service party 3 is a shopping website, which holds data such as the user's shopping habits, payment habits, and payment accounts. For another example, among a plurality of service parties related to a medical service, each service party can be a hospital, a physical examination institution, etc. For example, service party 1 is hospital A, and diagnosis and treatment records of a corresponding user such as age, gender, symptoms, diagnosis results, treatment plans, and treatment result are used as local service data; and service party 2 can be physical examination institution B, and physical examination record data of a corresponding user such as age, gender, symptoms, and physical examination conclusions, are used as local service data.

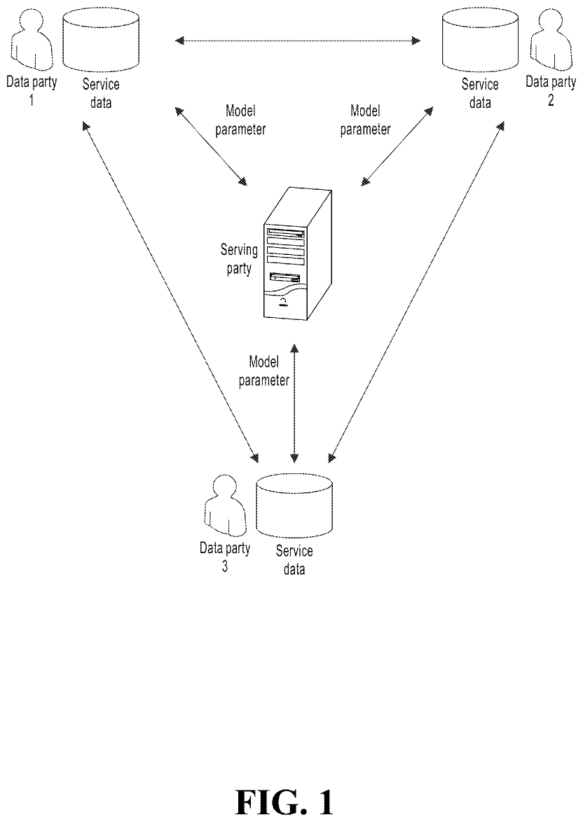

An implementation architecture of federated learning is shown in FIG. 1. In practice, a service party can serve as a data holder, or can transfer data to a data holder, and the data holder participates in joint training of a service model. Therefore, in FIG. 1 and the following description, all parties other than the serving party that participates in joint training are collectively referred to as data parties. One data party usually can correspond to one service party. In an optional implementation, one data party can alternatively correspond to a plurality of service parties. The data party can be implemented by a device, a computer, a server, etc.

In the implementation architecture, two or more data parties can jointly train a service model. Each data party can perform local service processing on local service data by using a trained service model. The serving party can assist each service party in federated learning, for example, assist in non-linear computation, comprehensive model parameter computation, or gradient computation. A form of the serving party shown in FIG. 1 is another party, such as a trusted third party, that is separately disposed independent of each service party. In practice, serving parties can alternatively be distributed in the service parties or include the service parties. A secure computation protocol (such as secret sharing) can be used between the service parties to complete joint auxiliary computation. Implementations are not limited in this specification.

As shown in FIG. 1, in the implementation architecture of federated learning, the serving party can initialize a global service model and distribute the global service model to each service party. Each service party can locally compute gradients of model parameters based on the global service model determined by the serving party, and update the model parameters based on the gradients. The serving party comprehensively computes the gradients of the model parameters or the jointly updated model parameters, and feeds back the gradients and the jointly updated model parameters to each service party. Each service party updates local model parameters based on the received model parameters or gradients of the model parameters. This is performed cyclically, and a service model suitable for each service party is finally trained.

Federated learning can be divided into horizontal federated learning (feature alignment), vertical federated learning (sample alignment), and federated transfer learning. The implementation architecture provided in this specification can be an architecture applied to various types of federated learning, and is particularly applicable to horizontal federated learning, that is, each service party provides a part of independent samples.

To reduce a communication amount and improve model training efficiency, this specification proposes a federated learning method for updating model parameters in phases and groups. Based on the technical concept, in a federated learning process, in a first phase, a data party fully updates model parameters and uploads updated model parameters in groups to increase a convergence speed, where this phase can be referred to as a full update phase; and in a second phase, the data party updates the model parameters in groups and uploads updated model parameters in groups to improve model performance, where this phase can be referred to as a local update phase. For a single data party, a transition between the first phase and the second phase of the data party can be determined by using a phase transition indicator.

The following describes in detail a method for jointly training a service model based on the technical concept of this specification.

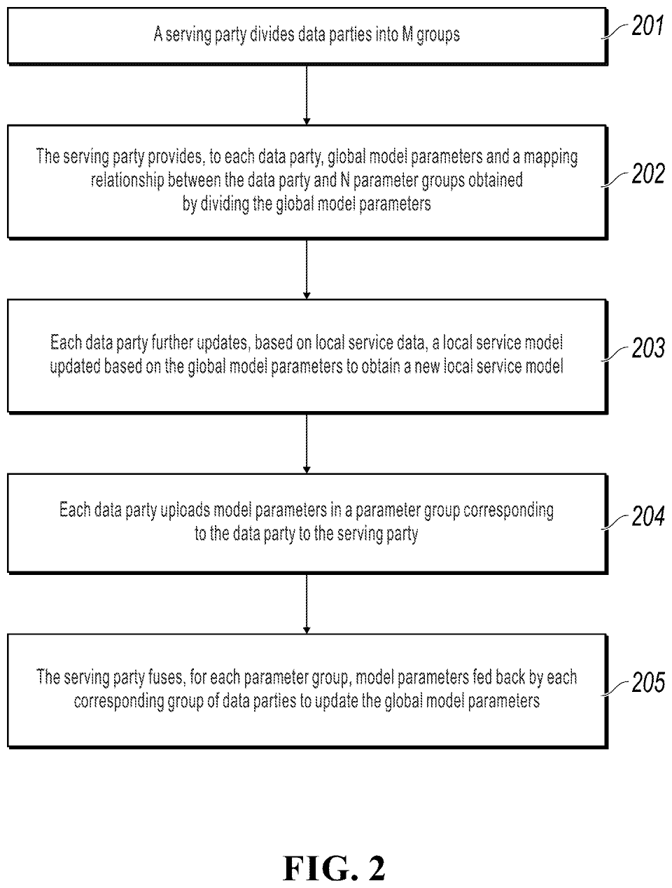

FIG. 2 is a schematic diagram illustrating a procedure for jointly training a service model, according to one or more embodiments of this specification. The procedure relates to a serving party and a plurality of data parties. The serving party or a single serving party can be any computer, device, server, etc. that has a specific computing capability, for example, the serving party and the data party shown in FIG. 1. FIG. 2 shows a period of federated learning. The following describes steps in detail.

First, in step 201, the serving party divides the data parties into M groups. It can be understood that, based on the technical concept of this specification, the data parties can upload model parameters in groups to the serving party. Therefore, the serving party can group the data parties in advance. M is an integer greater than 1.

According to an implementation, the serving party can randomly divide the data parties into M groups. The “random” described here can include at least one of the following: a group into which a single data party is grouped is random, data parties grouped into a group with a single data party are random, and a quantity of group members in a single group is random and not less than 1. For example, 100 data parties are randomly divided into 10 groups, where some groups each include 10 data parties, some groups each include 11 data parties, some groups each include 8 data parties, etc.

According to an implementation, the plurality of data parties can be grouped based on a quantity of service data held by the data party. For example, the data parties are grouped with a target that total quantities of service data held by data parties in the groups are equal.

In another implementation, there can be another grouping method, and details are omitted here for simplicity.

In another aspect, model parameters in a service model can also be grouped. When a quantity of model parameter groups and a quantity of data party groups are both N (in this case, M=N), N groups of data parties are in a one-to-one mapping relationship with N groups of model parameters. Generally, the model parameters in the service model can be pre-grouped. Grouping of the data parties can be based on grouping of the model parameters. N can be a predetermined positive integer. When M is less than N, a single group of data parties can correspond to a plurality of groups of model parameters. When M is greater than N, a single group of model parameters can correspond to a plurality of groups of data parties. Actually, even if M=N, a single group of data parties possibly correspond to a plurality of groups of model parameters, and a single group of model parameters possibly correspond to a plurality of groups of data parties. In conclusion, a single group of data parties in the M groups of data parties corresponds to at least one parameter group, and a single parameter group in the N parameter groups correspond to at least one group of data parties.

When the service model is a neural network, a quantity of data party groups can be consistent with a quantity of neural network layers of the service model. As such, each group of data parties can correspond to one layer of neural network. Optionally, the quantity of data party groups is possibly less than the quantity of neural network layers of the service model. As such, at least one parameter group can include a plurality of layers of neural networks.

In one or more embodiments, the N groups of model parameters respectively correspond to N group identifiers, and one of the N group identifiers are allocated to the data party in each group. To be specific, group identifiers of the model parameters are allocated to the groups of data parties randomly or based on a specific rule. The group identifiers can randomly correspond to the data party groups after the data party groups are determined, or the group identifiers of the model parameters can be directly randomly allocated to the data parties to simultaneously group the data parties and determine the model parameters corresponding to the data parties. When the model parameters are grouped based on a quantity of neural network layers, the group identifier of the data party can use a number of a layer at which the model parameter corresponding to the data party is located. In an example, numbers of the neural network layers are respectively from 0 to N−1, which are N numbers in total. The N numbers are randomly allocated to the data parties to simultaneously group the data parties and obtain mapping relationships between the data parties and the layers of neural networks (respectively corresponding to the parameter groups).

According to one or more embodiments, when grouping of the data parties is determined based on grouping of the model parameters, the plurality of data parties can be grouped based on a mapping relationship between a quantity of services held by the data party and a quantity of model parameters in a single group. For example, when the service model is a neural network and a single layer of neural network corresponds to a group of model parameters, a data party correspondingly allocated to a layer with a larger quantity of neurons holds a larger quantity of service data.

It is worthwhile to note that, in the process of jointly updating a service model, the serving party can re-group the data parties in each interaction period, or can group the data parties only once in an initial period, and the grouping continues to be used in subsequent periods. Implementations are not limited here.

Then, through step 202, the serving party provides, to each data party, current global model parameters and a mapping relationship between the data party and N parameter groups obtained by dividing the global model parameters. It can be understood that, in an initial period of federated learning, the current global model parameters can be model parameters initialized by the serving party, and in another period of federated learning, the current global model parameters can be model parameters updated by the serving party based on model parameters fed back the data parties.

Based on the technical concept of this specification, each data party feeds back only a part of model parameters (referred to as some model parameters here) in all model parameters to the serving party. In step 201, a purpose of grouping the data parties is to determine which data parties feed back which model parameters. Therefore, in step 202, a corresponding group identifier (such as a j^{th} group) of a parameter group corresponding to each data party or a parameter identifier (such as wij) of each model parameter can be provided to the data party, so that the data party provides corresponding model parameters based on the group identifier.

In an optional embodiment, one data party (or a group of data parties in which the data party is located) can further correspond to one or more parameter groups. Implementations are not limited here. In this case, a single data party can feed back model parameters in a plurality of parameter groups corresponding to the data party to the serving party. A first party serving as any one of the plurality of data parties is used as an example, and the first party can at least have a mapping relationship with a first parameter group. The first parameter group can be any one of the N groups of model parameters.

Next, in step 203, each data party further updates, based on local service data, a local service model updated based on the global model parameters to obtain a new local service model. A single data party can update a local service model by using a full quantity of global model parameters, or can update some model parameters in a corresponding group. For example, in a phase of fully updating model parameters, the single data party can update the local service model by using the full quantity of global model parameters; and in a phase of locally updating the model parameters, the single data party can update the local service model by using the full quantity of global model parameters, or can update the local service model by using some model parameters in a parameter group in the global model parameters that correspond to the data party. For example, the data party in an i^{th} group updates only a model parameter at an i^{th} layer of neural network (corresponding to an i^{th} parameter group).

For a single data party, a full update phase can be a phase of fully updating model parameters in a process of training a local service model by using local service data, and a local update phase can be a phase of locally updating the model parameters in the process of training the local service model by using the local service data. In a possible design, in the full update phase, the single data party receives the full quantity of global model parameters from the serving party, fully updates the model parameters in the local service model, and then processes service data locally used as training samples by using an updated local service model, and fully updates the model parameters in several rounds in a current training period. In other words, gradients of all the model parameters are computed to update all the model parameters based on the gradients. In the local update phase, the single data party can update the local service model by using the full quantity of model parameters or some model parameters in a corresponding parameter group, and then processes service data locally used as training samples by using an updated local service model, computes gradients of only the some model parameters in the corresponding parameter group in several rounds in a current training period, and updates these model parameters. For example, a data party j corresponding to an i^{th} group of model parameters can fix model parameters in another group, gradients of only the i^{th} group of model parameters are computed, and the i^{th} group of model parameters are updated.

It is worthwhile to note that, regardless of the full update phase or the local update phase, a single data party (denoted as j) can just upload some model parameters wij (the i^{th} group of model parameters of the j^{th} data party) in a group (for example, the i^{th} group) corresponding to a current period. For example, the service model is N layers of neural networks, and the N groups of data parties respectively correspond to the N layers of neural networks. Data parties grouped into a second group can feed back model parameters at a second layer of neural network to the serving party. Therefore, in an entire federated learning process, a communication data amount can be greatly reduced.

In some optional implementations, parameters such as training time (for example, 5 hours) and a quantity of training periods (for example, 1000 interaction periods) of the full update phase can be determined through negotiation between serving parties or data parties, or determined by the serving party, and the data parties enter the local update phase of federated learning based on the technical concept of this specification together.

In some other optional implementations, each data party can measure, by using a phase transition indicator, whether a current period of the data party is in the full update phase or the local update phase. The phase transition indicator can be an indicator used to measure a capability of processing local service data of a single data party by a jointly trained service model. To be specific, after the jointly trained service model has a certain capability of processing the local service data of the single data party, the jointly trained service model can locally update model parameters in the local update phase.

In an optional implementation, the phase transition indicator can be represented by at least one model performance in an accuracy rate, a model loss, etc. When the phase transition indicator satisfies a full update stop condition, the single data party can enter the local update phase. Stop conditions are different based on different phase transition indicators. In one or more embodiments, the phase transition indicator can be an accuracy rate. After updating the local service model by using the current global model parameters provided by the serving party, the single data party processes a local verification set by using the updated local service model to obtain an accuracy rate. For example, the stop condition is that the accuracy rate is greater than a predetermined accuracy threshold. In another embodiment, the phase transition indicator is a model loss. The single data party uses the updated local service model to process the local verification set in a plurality of batches, and one model loss is determined in each batch. For a plurality of consecutive batches, whether a single decrease amplitude of the model loss is less than a predetermined value (such as 0.001) or whether an entire decrease amplitude is less than a predetermined value (such as 0.01) is used as the phase transition indicator. In other words, the stop condition is that a decrease amplitude of the model loss is less than a predetermined amplitude. In one or more embodiments, the data party can further detect whether a loss function tends to be stable in a plurality of (such as 10) recent training periods (periods of interaction with the data party), for example, a decrease amplitude is less than a predetermined value (such as 0.001), as the phase transition indicator. In other words, in this case, the stop condition can be that a predetermined quantity of consecutive decrease amplitudes of the model loss are less than a predetermined amplitude.

In more embodiments, the data party can alternatively use other evaluation indicators, or use other methods to determine the phase transition indicator to determine whether the full update phase ends. After the full update phase ends, the single data party can enter the local update phase. To be specific, in each training periods, in a process of locally updating model parameters in a plurality of rounds, only model parameters in a group corresponding to a corresponding training period are updated, for example, the first party updates only the model parameters in the first parameter group.

In a possible design, after entering the local update phase, the single data party can further detect the phase transition indicator. When the phase transition indicator satisfies a full update activation condition, the single data party re-enters the full update phase to further fully update the model parameters in the service model. The activation condition here can also be referred to as a full update phase wakeup condition. For example, the activation condition can be that it is detected that a decrease amplitude of a model loss is greater than a predetermined activation value (such as 0.1).

Further, through step 204, each data party uploads model parameters in a parameter group corresponding to the data party to the serving party. Specifically, an i^{th} data party grouped into a j^{th} group feeds back model parameters wi, j in a j^{th} parameter group (such as a j^{th} layer of neural network) to the serving party. The first party described above is used as an example. The first party can upload, to the serving party, at least updated parameter values of the model parameters corresponding to the first parameter group. For ease of description, the parameter values of the model parameters corresponding to the first parameter group can be denoted as a first parameter set, and the first party can feed back the updated first parameter set for the first parameter group. Optionally, data uploaded by the data party to the serving party can be further encrypted in a pre-agreed method, such as homomorphic encryption or secret sharing, to further protect data privacy.

As such, through step 205, the serving party further fuses, for each parameter group, model parameters fed back by each corresponding group of data parties to update the global model parameters. For example, the serving party can separately fuse the groups of model parameters in a sequence from a first group of model parameters to an N^{th} group of model parameters, or can fuse the model parameters in the parameter groups in a sequence in which the groups of data parties feed back the model parameters.

The serving party can fuse the groups of model parameters by using the following method: performing weighted averaging, taking a minimum value, taking a median value, etc. Implementations are not limited here. In a weighted averaging method, weights can be set to be consistent or inconsistent. If the weights are set to be inconsistent, a weight corresponding to each data party can be positively correlated with a quantity of service data held by the corresponding data party. A result of fusing the groups of model parameters can be used to update the global model parameters.

The above step 201 to step 205 can be considered as a summarized period during which the serving party assists in performing a federated learning process. Based on the technical concept of this specification, a sequence of performing steps in step 201 to step 205 is not limited to the sequence provided in the above embodiment. For example, step 201, step 202, and step 203 can be performed in the above sequence, or can be performed simultaneously, or can be performed in a mixed method. Mixed execution is used as an example. The serving party can use step 201 to provide the current global model parameters to each data party, and then use step 202 to group the data parties and provide corresponding group identifiers to the data parties. In an optional implementation, the serving party can determine and provide the corresponding group identifier to the data party when the data party trains the local service model by using the local service data.

In addition, when it is determined that grouping of the data parties remains unchanged in the entire federated learning process, only in a first training period, the serving party groups the plurality of data parties and determines model parameters corresponding to the corresponding groups, or before training starts, the serving party pre-determines the groups and determines the model parameters corresponding to the corresponding groups, and provide the model parameters to the data parties. In the subsequent procedure, the serving party no longer performs step 201 and step 202 to provide the mapping relationship between each data party and the parameter groups to the data party.

With reviewing the above procedure, in the process of jointly updating a service model based on privacy protection by using the procedure shown in FIG. 2, because the plurality of data parties serving as training members are grouped, and each data party uploads only a part of model parameters to the serving party, so that an amount of communication between each data party and the serving party and a quantity of data processed by the serving party can be effectively reduced in a multi-party cooperation process, thereby avoiding communication blocking and helping improve overall training efficiency.

In addition, for a single data party, the training process can be divided into two phases. In the full update phase, the training member fully updates the model parameters and locally updates updated model parameters in groups, which helps increase a convergence speed and improve joint training efficiency. In the local update phase, the training member locally updates the model parameters in groups and locally uploads updated model parameters, which helps improve model performance, thereby improving a capability of processing service data by a jointly trained service model.

The method for jointly updating a service model provided in this specification is applicable to any federated learning process, and especially, when there are a large quantity of data parties or a large quantity of training samples, the above effects are more significant. In addition, the model is not sparsified or quantized in the above process, so that there is no loss of model information, and there is little impact on model convergence. Random grouping of the training members also ensures robustness of a federated model on the training data.

According to one or more embodiments of another aspect, a system for jointly updating a service model is provided, including a serving party and a plurality of data parties. The plurality of data parties jointly train a service model based on privacy protection with the assistance of the serving party, and the service model is used to process service data to obtain a corresponding service processing result.

The serving party is configured to provide, to each data party, global model parameters and a mapping relationship between each data party and N parameter groups obtained by dividing the global model parameters; each data party is configured to update a local service model by using the global model parameters, and further update an updated local service model based on local service data to obtain a new local service model, to upload model parameters in a parameter group corresponding to the data party to the serving party; and the serving party is further configured to fuse, for each parameter group, the received model parameters to update the global model parameters.

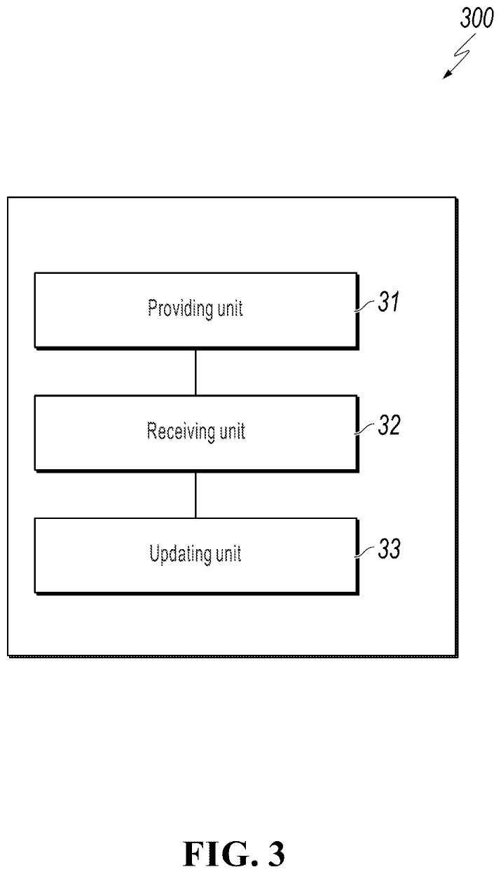

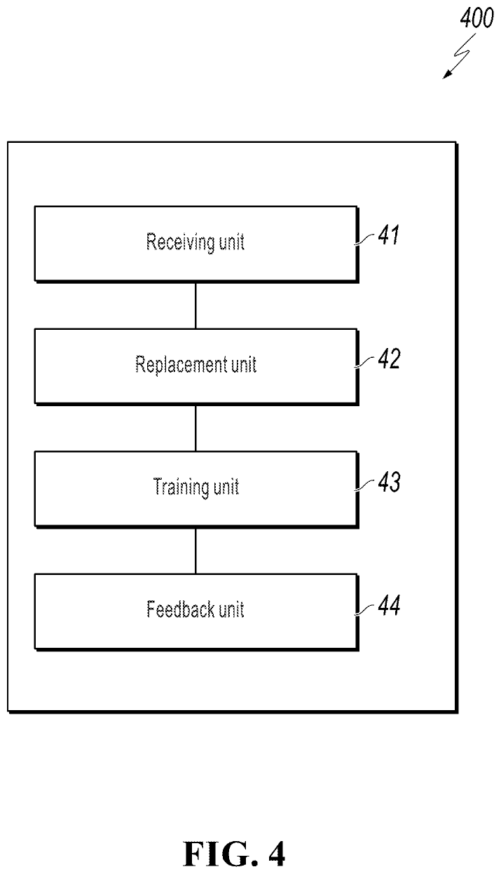

Specifically, as shown in FIG. 3 and FIG. 4, a serving party and a single data party can respectively perform corresponding operations by using an apparatus 300 and an apparatus 400 for jointly updating a service model.

As shown in FIG. 3, the apparatus 300 can include: a providing unit 31, configured to provide, to a first party, current global model parameters and a mapping relationship between the first party and a first parameter group in N parameter groups obtained by dividing the global model parameters, so that the first party updates a local service model by using the current global model parameters, and feeds back a first parameter set for the first parameter group after further updating an updated local service model based on local service data to obtain a new local service model; a receiving unit 32, configured to receive the first parameter set fed back by the first party; and an updating unit 33, configured to update the first parameter group in the global model parameters based on the first parameter set and another parameter set related to the first parameter group that is received from another data party, and further update the current global model parameters based on updating of the first parameter group.

It can be understood that, actually, the receiving unit 32 can be further configured to receive parameter sets fed back by other data parties, not just the first parameter set fed back by the first party. Here, due to consistency between processes of interaction between the serving party and the data parties, only interaction between the first party in the data parties and the serving party is described, and therefore, only the parameter set related to the first party is described.

As shown in FIG. 4, a first party in a plurality of data parties is used as an example. The apparatus 400 can include: a receiving unit 41, configured to receive, from a serving party, current global model parameters and a mapping relationship between the first party and a first parameter group in N parameter groups obtained by dividing the global model parameters; a replacement unit 42, configured to update a local service model by using the current global model parameters; a training unit 43, configured to further update an updated local service model based on local service data to obtain a new local service model; and a feedback unit 44, configured to feed back, to the serving party, a first parameter set obtained by updating the first parameter group, so that the serving party updates the first parameter group in the global model parameters based on the first parameter set and another parameter set related to the first parameter group that is received from another data party, to update the current global model parameters.

It is worthwhile to note that, the apparatus 300 shown in FIG. 3 and the apparatus 400 shown in FIG. 4 are respectively embodiments of the apparatuses disposed in the serving party and the data party in the method embodiment shown in FIG. 2, so as to implement functions of corresponding service parties. Therefore, the corresponding descriptions in the method embodiment shown in FIG. 2 are also applicable to the apparatus 300 or the apparatus 400, and details are omitted here for simplicity.

According to one or more embodiments of another aspect, a computer-readable storage medium is further provided. The computer-readable storage medium stores a computer program, and when the computer program is executed in a computer, the computer is enabled to perform an operation corresponding to the serving party or the data party in the method described with reference to FIG. 2.

According to one or more embodiments of still another aspect, a computing device is further provided, including a memory and a processor. The memory stores executable code, and when executing the executable code, the processor implements an operation corresponding to the serving party or the data party in the method described with reference to FIG. 2.

A person skilled in the art should be aware that in the above one or more examples, functions described in the embodiments of this specification can be implemented by hardware, software, firmware, or any combination thereof. When implemented by software, these functions can be stored in a computer-readable medium or transmitted as one or more instructions or code on a computer-readable medium.

The above specific implementations further describe in detail the objectives, technical solutions, and beneficial effects of the technical concept of this specification. It should be understood that the above descriptions are merely specific implementations of the technical concept of this specification, and are not intended to limit the protection scope of the technical concept of this specification. Any modification, equivalent replacement, or improvement made based on the technical solutions in the embodiments of this specification shall be included in the protection scope of the technical concept of this specification.

What is claimed is:

1. A computer-implemented method for jointly updating a service model, wherein a plurality of data parties jointly train the service model based on privacy protection with assistance of a serving party, and the computer-implemented method comprises:
providing, by a serving party to each data party of a plurality of data parties, global model parameters of a service model and a mapping relationship between the data party and N parameter groups obtained by dividing the global model parameters;
updating, by each data party, a local service model by using the global model parameters to obtain an updated local service model;
further updating, by each data party, the updated local service model based on local service data to obtain a new local service model; and
uploading, by each data party to the serving party, model parameters in a parameter group corresponding to the data party; and
fusing, by the serving party for each parameter group, the model parameters to update the global model parameters.

2. The computer-implemented method according to claim 1, wherein the further updating, by each data party, the updated local service model based on local service data to obtain a new local service model comprises:
detecting, by each data party, a current phase transition indicator by using the local service data after updating the local service model by using the global model parameters;
entering, by a data party whose phase transition indicator satisfies a full update stop condition, a local update phase; and
updating, by the data party entering the local update phase, model parameters in a parameter group corresponding to the data party.

3. The computer-implemented method according to claim 2, wherein the phase transition indicator is model performance of the updated local service model, and the stop condition is that the model performance satisfies a predetermined value.

4. The computer-implemented method according to claim 1, wherein the mapping relationship is determined by operations comprising:
dividing the plurality of data parties into M groups; and
determining mapping relationships between the M groups of data parties and the N parameter groups, wherein a single group of data parties corresponds to at least one parameter group, and a single parameter group corresponds to at least one group of data parties.

5. The computer-implemented method according to claim 4, wherein the dividing the plurality of data parties into M groups comprises:
dividing the plurality of data parties into M groups such that quantities of service data held by the groups of data parties are consistent.

6. The computer-implemented method according to claim 4, wherein the dividing the plurality of data parties into M groups comprises:
dividing the plurality of data parties into M groups such that a quantity of service data held by a single data party is positively correlated with a quantity of model parameters comprised in a corresponding parameter group.

7. The computer-implemented method according to claim 1, wherein the fusing, by the serving party for each parameter group, the model parameters to update the global model parameters comprises:
fusing, by the serving party for each parameter group, the model parameters to update the global model parameters in at least one of the following manners: performing weighted averaging, taking a minimum value, or taking a median.

8. A computer-implemented method for jointly updating a service model, comprising:
providing, by a serving party to a first party, current global model parameters and a mapping relationship between the first party and a first parameter group in N parameter groups obtained by dividing global model parameters, wherein:
the serving party assists a plurality of data parties in jointly training a service model based on privacy protection,
the plurality of data parties comprise the first party, and
the current global model parameters are for use by the first party to update a local service model to obtain an updated local service model;
receiving, by the serving party, a first parameter set fed back by the first party, wherein the first parameter set is obtained after further updating an updated local service model based on local service data of the first party; and
updating, by the serving party, the first parameter group in the global model parameters based on the first parameter set and another parameter set related to the first parameter group that is received from another data party of the plurality of data parties; and
updating, by the serving party, the current global model parameters based on the updating the first parameter group.

9. The computer-implemented method according to claim 8, wherein the mapping relationship between the first party and the first parameter group is determined by operations comprising:
dividing the plurality of data parties into M groups, wherein a single group of data parties corresponds to at least one data party, and the first party belongs to a first group in the M groups of data parties; and
determining mapping relationships between the M groups of data parties and the N parameter groups, wherein a single group of data parties corresponds to at least one parameter group, a single parameter group corresponds to at least one group of data parties, and a parameter group corresponding to the first group is the first parameter group.

10. The computer-implemented method according to claim 9, wherein the dividing the plurality of data parties into M groups comprises:
dividing the plurality of data parties into M groups such that quantities of service data held by the groups of data parties are consistent; or
dividing the plurality of data parties into M groups such that a quantity of service data held by a single data party is positively correlated with a quantity of model parameters comprised in a corresponding parameter group.

11. The computer-implemented method according to claim 8, wherein the updating the first parameter group in the global model parameters based on the first parameter set and another parameter set related to the first parameter group that is received from another data party comprises:
fusing the first parameter set and the another parameter set related to the first parameter group in at least one of the following manners: performing weighted averaging, taking a minimum value, or taking a median; and
updating the first parameter group in the global model parameters based on a fusion result.

12. The computer-implemented method according to claim 8, wherein the updating the current global model parameters based on the updating the first parameter group comprises:
separately updating other parameter groups based on corresponding parameter sets fed back by multiple data parties respectively corresponding to the other parameter groups, to update the current global model parameters.

13. A computer-implemented method for jointly updating a service model, comprising:
receiving, from a serving party by a first party in a plurality of data parties that jointly train a service model based on privacy protection with assistance of the serving party, current global model parameters and a mapping relationship between the first party and a first parameter group in N parameter groups obtained by dividing global model parameters;
updating a local service model by using the current global model parameters to obtain an updated local service model;
further updating the updated local service model based on local service data to obtain a new local service model; and
feeding back, to the serving party, a first parameter set obtained by updating the first parameter group, wherein the first parameter set is used, together with another parameter set related to the first parameter group that is from another data party, to update the first parameter group in the global model parameters to update the current global model parameters.

14. The computer-implemented method according to claim 13, wherein the further updating the updated local service model based on local service data to obtain a new local service model comprises:
detecting a phase transition indicator of the updated local service model by using the local service data; and
entering a local update phase of updating the first parameter group in response to that the phase transition indicator satisfies a full update stop condition.

15. The computer-implemented method according to claim 14, wherein a full update phase of updating all model parameters in the local service model continues in response to that the phase transition indicator does not satisfy the stop condition.

16. The computer-implemented method according to claim 14, wherein the phase transition indicator is model performance of the updated local service model, and the stop condition is that the model performance satisfies a predetermined value.

17. The computer-implemented method according to claim 14, wherein in the local update phase, the further updating the updated local service model based on local service data to obtain a new local service model comprises:
detecting whether the phase transition indicator satisfies a full update activation condition; and
re-entering a full update phase of updating all model parameters in the local service model in response to that the phase transition indicator satisfies the activation condition.
